(19) United States
(12) Patent Application Publication
(10) Pub. No.: US 2025/0016207 A1
(43) Pub. Date: Jan. 9, 2025

(54) SYSTEM AND METHOD FOR FACILITATING AN OPTIMAL MODE SET FOR ESTABLISHING A CALL

(71) Applicant: JIO PLATFORMS LIMITED, Ahmedabad (IN)

(72) Inventors: Birendra Singh BISHT, Navi Mumbai (IN); Harbinder Pal Singh SAINI, Navi Mumbai (IN); Anurag SINHA, Mumbai (IN); Priti KELKAR, Mumbai (IN); Suman NASKAR, Mumbai (IN)

(21) Appl. No.: 18/247,471

(22) PCT Filed: Mar. 16, 2023
(86) PCT No.: PCT/IB2023/052581

§ 371 Date: Mar. 31, 2023

(30) Foreign Application Priority Data
Mar. 30, 2022 (IN) 202221018949

(51) Int. Cl. H04L 65/1069; H04L 65/1016; H04L 65/1046; H04L 65/1104

(52) U.S. Cl. CPC H04L 65/1069; H04L 65/1016; H04L 65/1046; H04L 65/1104

(57) ABSTRACT

The present disclosure relates to a system and a method for mode set reduction during encoding and decoding. The system may include a converge telephony application server (CTAS) that may be configured to receive one or more predefined request signals from one or more user equipment (UE) and extract a set of attributes from the one or more predefined request signals, the set of attributes pertaining to a set of modes with standardized bit rate at which speech modulation takes place. The CTAS may further determine, from the set of attributes extracted, if the set of modes are specified and add a predefined number of modes to the one or more predefined request signals if the set of modes are unavailable or restrict the set of modes to the predefined number of modes if the set of modes exceed the predefined number of modes.

### FIELD OF INVENTION

The present invention relates generally to telecommunication systems, and more particularly to next generation network devices to enable mode set restriction while establishing a call.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Speech signals are usually transmitted over telephone channels to telephone sets. A typical telephone set transforms the voice signals into electrical (analog) signals which are transmitted to the local telephone exchange and then through the wide-area telephone network to the receiving party. Although speech typically covers frequencies from 30 to 10,000 Hz, most of the energy is in the range from 200 to 3500 Hz. Consequently, most telephone communications are bandlimited to between 200 and 3500 Hz to save transmission costs. This savings comes about since costs are directly related to the bandwidth (i.e., the range of frequencies transmitted) and (as will be described later) band limiting allows a greater number of voice channels to be multiplexed over a high-bandwidth channel. It must be pointed out, however, that the nominal bandwidth of a voice channel is defined as 4000 Hz, with the additional bandwidth allowing a guard band on either side of the speech signal to reduce interference between channels. Adaptive Multi-Rate Wideband (AMR-WB) is a patented wideband speech audio coding operating at eight-bit rates in the range of 4.75 to 12.2 kbps and was specifically designed to improve link robustness. This technology was initially developed for Global System for Mobile communication (GSM) systems, the single most deployed 2G mobile telecommunication standard worldwide. The AMR-WB has eight mode-sets (0 to 7) and 1 Information framework (SID) mode set. Each mode-set specifies a standardised bit rate at which speech modulation takes place. SID mode-set is used to detect silence period between speeches. In operator networks, Mean Opinion Score (MOS) calculated with the help of ITU recommended tools supporting PESQ and POLQA algorithms, suggest that mode-set value “2” and “3” having bit rates 12.65 Kbps and 14.25 Kbps respectively provides best and optimum quality. Higher mode-sets use more-bandwidths. However, the modes evaluated with the MOS scores evaluated are comparable with mode-set: 3.

Currently the devices, which are in field, send all mode sets in session description protocol (SDP) to establish voice call. It is being observed that most of the devices use mode-set: 7 for modulation. Even though underlying network condition is good, higher mode-set is being used in non-noisy environment. This leads to unnecessary bandwidth reservation at LTE backhaul leading to wastage of bandwidth which is the most critical resource of a network.

To mitigate this, a network operator may want the IP multimedia systems (IMS) nodes to restrict the “mode-set” value to 3. One of the possible solutions to achieve this is by transcoding higher bit rates to lower bit rates at border gateways. But transcoding of real time transport protocol (RTP) packets encoded in higher mode-sets is not an optimum solution because transcoding will lead to reduction in voice quality and capacity of border gateways drastically.

There is, therefore, a requirement in the art for an effective system and method that can overcome aforementioned problems in the art and can enable a faster next generation based service for restriction of mode set number without compromising on signal quality.

### OBJECTS OF THE PRESENT DISCLOSURE

Some of the objects of the present disclosure, which at least one embodiment herein satisfies are as listed herein below.

It is an object of the present disclosure to facilitate an effective, concurrent, and improved signal quality with a restricted mode set value.

It is an object of the present disclosure to provide for a system that maintains an optimal bandwidth.

It is an object of the present disclosure to facilitate careful and efficient use of resources in the network.

### SUMMARY

This section is provided to introduce certain objects and aspects of the present invention in a simplified form that are further described below in the detailed description. This summary is not intended to identify the key features or the scope of the claimed subject matter.

In order to achieve the aforementioned objectives, the present invention provides a system and a method for mode set restriction during speech modulation in a communication network. The system may include at least one converge telephony application server (CTAS) in communication with a user equipment (UE) associated with a predefined circle in the communication network and a centralized database. The at least one CTAS may be operatively coupled to a processor, the processor further coupled to a memory, the memory storing instructions, on execution of which, the processor causes the at least one CTAS to receive one or more predefined request signals from the UE, extract a set of attributes from the one or more predefined request signals, the set of attributes pertaining to a set of modes, where the set of modes pertain to a standardized bit rate for speech modulation, determine, from the set of attributes extracted, if the set of modes are specified, add a predefined number of mode-sets to the one or more predefined request signals if the set of modes are unavailable; and restrict the set of modes to the predefined number of mode-sets, if the set of modes exceed the predefined number of mode-sets.

In an embodiment, the predefined number of mode-sets is within a predefined frequency range.

In an embodiment, the at least one CTAS is operatively coupled to one or more communication interfaces for communicating with the UE via one or more channels selected from a group consisting of: telephonic calls, web-based voice communications, voice-over-IP communications, where the one or more communication interfaces are associated with a session description protocol (SDP), the SDP including one or more control signals for a plurality of service sessions and protocols for service use by the UE.

In an embodiment, the one or more predefined request signals may include a field for the SDP, said field being configured for setting the predefined number of mode-sets by a user associated with the UE as mandated by a set of predefined instruction protocol.

In an embodiment, the CTAS is further configured to modify the set of modes to the predefined number of mode sets if the set of modes is specified in the SDP and is not within the predefined frequency range.

In an embodiment, the system may be configured to exceed the predefined number of mode-sets based on underlying network condition.

In an aspect, the method for mode set restriction during speech modulation in a communication network may include the steps of receiving, by a converge telephony application server (CTAS), one or more predefined request signals from a UE associated with a communication network. The CTAS may be operatively coupled to the communication network and a centralized database. The method may also include the step of extracting, by the CTAS, a set of attributes from the one or more predefined request signals, the set of attributes pertaining to a set of modes pertaining to a standardized bit rate for speech modulation and the step of determining, by the CTAS from the set of attributes extracted, if the set of modes are specified. Further, the method may include the step of adding, by the CTAS, a predefined number of mode-sets to the one or more predefined request signals, where the predefined number of mode-sets may be added if the set of modes are unavailable, and restricting, by the CTAS, the set of modes to the predefined number of mode-sets if the set of modes exceed the predefined number of mode sets.

In an aspect, the present invention provides a user equipment (UE) for mode set restriction during speech modulation in a communication network. The UE may include at least one converge telephony application server (CTAS) in communication with a communication network and a centralized database. The at least one CTAS may be operatively coupled to a processor, the processor further coupled to a memory, the memory storing instructions, on execution of which, the processor causes the at least one CTAS to receive one or more predefined request signals from the UE, extract a set of attributes from the one or more predefined request signals, the set of attributes pertaining to a set of modes, where the set of modes pertain to a standardized bit rate for speech modulation, determine, from the set of attributes extracted, if the set of modes are specified, add a predefined number of mode-sets to the one or more predefined request signals if the set of modes are unavailable, and restrict the set of modes to the predefined number of mode-sets, if the set of modes exceed the predefined number of mode-sets.

In an aspect, the present disclosure provides a non-transitory computer readable medium comprising machine-executable instructions that are executable by a processor to receive one or more predefined request signals from a UE, extract a set of attributes from the one or more predefined request signals, the set of attributes pertaining to a set of modes, where the set of modes pertain to a standardized bit rate for speech modulation, determine, from the set of attributes extracted, if the set of modes are specified, add a predefined number of mode-sets to the one or more predefined request signals if the set of modes are unavailable, and restrict the set of modes to the predefined number of mode-sets, if the set of modes exceed the predefined number of mode-sets.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIGS. 1A-1B illustrate exemplary network architecture in which or with which system of the present disclosure can be implemented, in accordance with an embodiment of the present disclosure.

FIGS. 2A-2B with reference to FIG. 1A, illustrates an exemplary representation of a network device, in accordance with an embodiment of the present disclosure.

FIG. 2C illustrates an exemplary representation of a CTAS application module, in accordance with embodiments of the present disclosure.

FIG. 3 illustrates an exemplary representation of a method flow diagram, in accordance with embodiments of the present disclosure.

FIG. 4 illustrates an exemplary computer system in which or with which embodiments of the present invention can be utilized in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The term “AMR/AMR-WB” relates to codecs that support at least 8 standard encoding modes. The mode-set parameter can be used to restrict the session mode set to a sub-set of the 8 standard modes. If a mode-set is specified, it must be honoured, and frames encoded with modes not specified within the sub-set must not be sent in any RTP payload or used in codec mode requests. In the absence of a mode-set parameter, the inclusive mode-set (0, 1, 2, 3, 4, 5, 6, 7) provides the default value.

The present system and method facilitate to overcome the above mentioned problems by restricting a mode set value in a predefined request signal sent from a user equipment to a predefined value without compromising quality of one or more signals between two or more UEs.

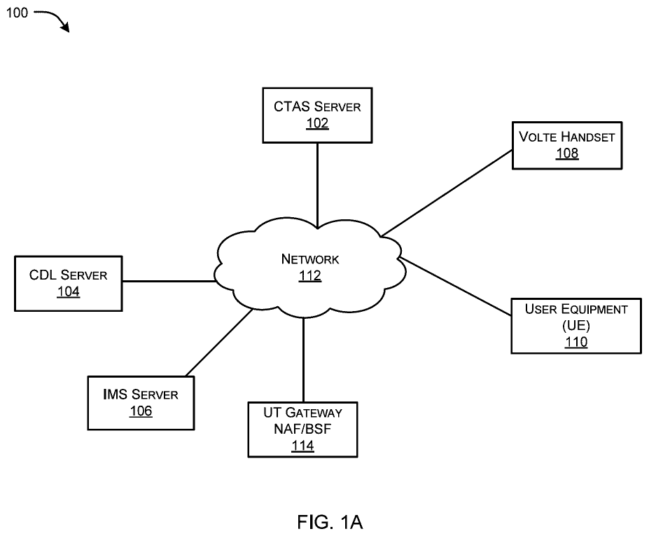

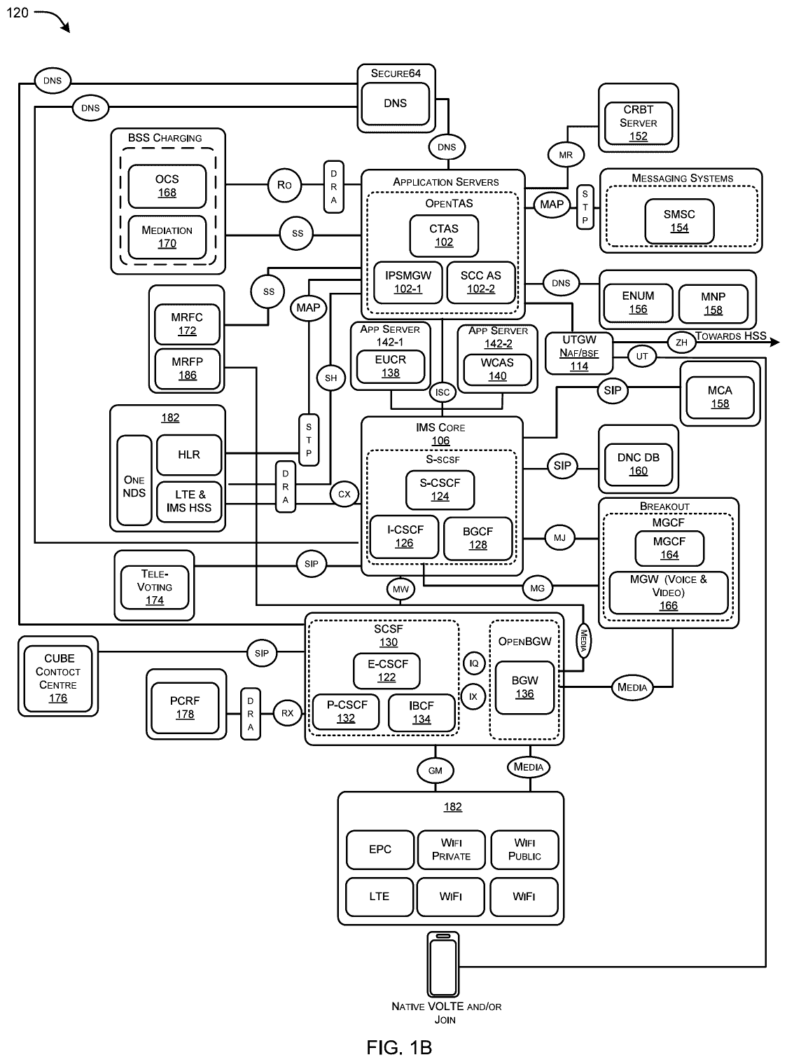

FIGS. 1A-1B illustrate exemplary network architecture 100 and 120 in which or with which system of the present disclosure can be implemented, in accordance with an embodiment of the present disclosure. As illustrated in representation 100 in FIG. 1A, a network device 102 (network device hereinafter interchangeably referred to as converge telephony application server or CTAS 102) may be configured to facilitate a user device 110 to restrict a mode set to a predefined value. The network device 102 may be configured as an application server and may be communicably operational or may be integrated with the Internet Protocol Multimedia Subsystem (IMS) server 106 (also interchangeably referred to as IMS or IMS core). The IMS server 106 may pertain to a vendor or service provider to enable a user equipment 110 to establish simultaneous communication. In an embodiment, the CTAS or the network device 102 may be implemented in an existing IMS implementation to facilitate network service corresponding to communication network 112. In an example, the communication network 112 may pertain to, for example, fifth generation (5G) network service.

The user equipment 110 (also interchangeably referred to as a user device or UE or terminal 110) may be at least one of a wireline device or wireless device. For example, the wireline device may be a landline phone, a terminal device or any other stationary device through which communication may be established. The wireless device may be a mobile device that may include, for example, cellular telephone, such as a feature phone or smartphone and other devices. The user device may not be limited to the above mentioned devices, but may include any type of device capable of wireline or wireless communication, such as a cellular phone, a tablet computer, a personal digital assistant (PDA), a personal computer (PC), a laptop computer, a media centre, a work station and other such devices.

In an embodiment, the communication network 112 pertaining to CTAS based IMS implementation may be a 5G network that may include at least one of a wireless network, a wired network or a combination thereof. The communication network 112 may be implemented as one of the different types of networks, such as Intranet, Local Area Network (LAN), Wide Area Network (WAN), Internet, and the like. Further, the network can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), Automatic repeat request (ARQ), and the like. In an embodiment, the communication network 112 may pertain to a 5G network that may be facilitated through, for example, Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a WIFI or other LAN access network, or a satellite or terrestrial wide-area access network such as a wireless microwave access (WIMAX) network. In an example embodiment, the communication network may enable 5G or 6G network based on subscription pertaining to the user/user device and/or through a Subscriber Identity Module (SIM) card. Various other types of communication network or service may be possible.

In an example, the communication network 112 may utilize different sort of air interface, such as a code division multiple access (CDMA), time division multiple access (TDMA), or frequency division multiple access (FDMA) air interface and other implementation. In an example embodiment, the wireline user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

As shown in FIG. 1B, in an example, the CTAS 102 may be session initiation application (SIP) server that is a 3GPP and RFC compliant implementation of LTE service architecture. The CTAS, at the centre of a voice core network, managing the connectivity between subscribers and the implementation of supplementary services. An Ro interface based online charging (OCS) 168 may be implemented in the telecom network. One or more charging data records (CDRs) generated by application servers, such as CTAS, can be used by a Mediation system 170 for reconciliation purpose. The CTAS 102 may further be operatively coupled to a Serving-Call Session Control Function (SCSCF) 124 that controls every service in an all-IP network and makes possible new subscriber services such as VOLTE, VoWiFi, RCS, and WebRTC. For example, the SCSCF 124 can act as a central control core and can offer session and service control, using predefined interfaces and application triggering mechanisms. One or more access elements and clients such as VOLTE Devices and operator 4G Voice Client, MGW 166 may be further associated with the CTAS 102. In an example, the CTAS 102 may be further coupled to an Element Management System (EMS) that can manage specific types of one or more network elements such as MRFC 172, tele-voting 174, and contact centre 176 within a telecommunication management network (TMN). A Centralised Data Layer (CDL) server 104 may further be operatively coupled to the CTAS 102. In an example, the CDL can maintain a mapping table between an ECI and Short-Distance Charging Area (SDCA) of a circle. During application commissioning process, the CDL instance of the circle (MNC) will download cell-id vs SDCA mapping table of the circle (MNC) from the centralized database. In an example, a UTGW (NAF and BSF) 114 provides a gateway to one or more networks for providing application-independent functions for mutual authentication of a user equipment and servers unknown to each other and for ‘bootstrapping’ the exchange of secret session keys afterwards. This allows the use of additional services like Mobile TV and PKI, which need authentication and secured communication. For example, the BSF is introduced by the application server (NAF), after an unknown UE device is trying to get service access: the NAF refers the UE to the BSF. UE and BSF mutually authenticate via 3GPP protocol AKA (Authentication and Key Agreement); additionally, the BSF sends related queries to the Home Subscriber Server (HSS). Afterwards, UE and BSF agree on a session key to be used for encrypted data exchange with the application server (NAF). When the UE again connects to the NAF, the NAF is able to obtain the session key as well as user-specific data from the BSF and can start data exchange with the end device (UE), using the related session keys for encryption.

The IMS server (106 of FIG. 1A and FIG. 1B) may include one or more modules or components that may enable to perform one or more functions. For example, the IMS server may be an existing IMS core including components/modules handling various functions such as, serving-call session control function (S-CSCF) module 124 and interrogating call session control function (I-CSCF) module 126. In an embodiment, the CTAS 102 may be integrated with a network of the IMS core and other application servers to provide a network service such as for example, a fifth generation (5G) network and may include a telephony application server (TAS), which may be considered as a general component used in a communication network to provide telephony applications and additional multimedia functions. In another example, the other application server may include Mobile number portability (MNP) server 158, which may provide number portability to users such as, for example, may allow retaining same number upon change in service provider. In an yet another example, another application server may include a Short Message Service Center (SMSC) 154 that may store, forward, convert and deliver Short Message Service (SMS) messages. Various other servers may be integrated to the CTAS enabled IMS implementation for enabling one or more services pertaining to communication network or 5G network.

In an embodiment, the network device or CTAS 102 may be communicably coupled or be integrated with one or more functional components such as, for example, a session initiation protocol (SIP) based application server.

Further, as shown in FIG. 1B, to provide various aspects of the network service (such as 5G network), the components of IMS server (such as S-CSCF, I-CSCF module) may also include components/modules that pertain to functions, for example, breakout gateway control function (BGCF) module 128, a media gateway control function (MGCF) module 164, interconnect border control function (IBCF) 134 and other components/modules. In general implementation, the BGCF module 128 may enable routing call signalling to and from the most appropriate S-CSCF module 124. The SCSF module 130 may further include an Emergency-Call Session Control Function 122. The E-CSCF 122 is a specialist platform which is designed to facilitate support for emergency services dialling. In this capacity, the E-CSCF 122 will take in requests from the P-CSCF 132 and S-CSCF 124 and route these emergency session requests to a suitable onward destination such as a PSAP (Public Safety Answering Point). Further, in general, the MGCF module 164 may be a SIP endpoint that can interface with security gateway (SGW) and may also control resources in media gateway (MGW) 166. The IBCF module 134 may enable boundary control between various service provider networks, thus providing CTAS enabled IMS network security in terms of signalling information. The IMS server may also include other existing components such as for example a component pertaining to MCA 160 that enables passengers to use their mobile phone on board an aircraft. A miniature cellular network is installed inside the aircraft. Mobile phones can connect to this network. Further, as shown in FIG. 1B, as the CTAS-IMS based implementation may be associated with another application server such as a Caller Ring Back Tone (CRBT) server 152 that allows the caller to hear subscriber pre-defined song or audio clip instead of standard ring tone until the subscriber picks up the call.

In an embodiment, CTAS 102 may be capable of handling VOLTE, M2M, Fixed-line (FLP), and Enterprise subscribers simultaneously. This makes CTAS a unique type of TAS which gives operational and engineering advantage to in managing the subscriber's growth in VOLTE, Fixed and Enterprise domain in most efficient way. In another embodiment, the CTAS 102 can be integrated with the NSN CSCFs for delivering MMTel Supplementary services to the VOLTE customers as well as to the customers who are using 4G Voice client over LTE or WiFi. The CTAS can support online and offline charging for subscribers. The CTAS 102 may further include IP Short Message Gateway (IPSMGW) that can handle SIP based messaging services for IMS subscribers. In addition, the IP-SM-GW will interact with the legacy SMSC 154 using MAP signalling in order to allow IMS to SMS conversion and distribution. The CTAS 102 may further include, but not limited to a service Centralization and Continuity Application Server (SCC AS). The SCC AS can acts as a back to back user agent within the IMS architecture and can facilitate service centralization, as well as coordination of Single Radio Voice Call Continuity (SR-VCC) handover procedures.

The CTAS 102 may comply with but not limited to AMR-WB. The 8 mode sets are shown in Table 1.

| | Mode | |
|---|---|---|
| Frame Content | Indicator | Frame Content |
| AMR 4.75 kbit/sec | 0 | AMR-WB 6.60 kbit/sec |
| AMR 5.15 kbit/sec | 1 | AMR-WB 8.85 kbit/sec |
| AMR 5.90 kbit/sec | 2 | AMR-WB 12.65 kbit/sec |
| AMR 6.70 kbit/sec | 3 | AMR-WB 14.25 kbit/sec |
| AMR 7.40 kbit/sec | 4 | AMR-WB 15.85 kbit/sec |
| AMR 7.95 kbit/sec | 5 | AMR-WB 18.25 kbit/sec |
| AMR 10.2 kbit/sec | 6 | AMR-WB 19.85 kbit/sec |
| AMR 12.2 kbit/sec | 7 | AMR-WB 23.05 kbit/sec |

In an embodiment, the CTAS may calculate a mean opinion score (MOS) with respect to the mode-sets. In an embodiment, at mode-set 3, an optimum MOS is achieved that helps provide best and optimum voice quality.

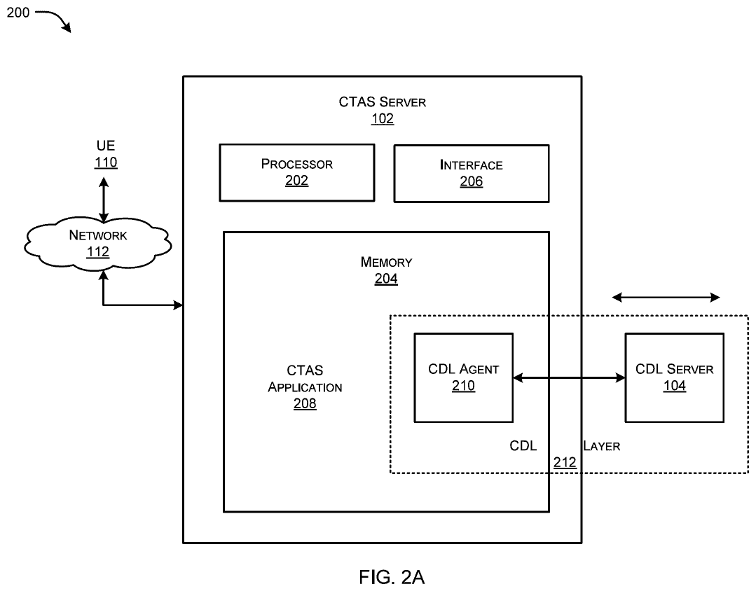

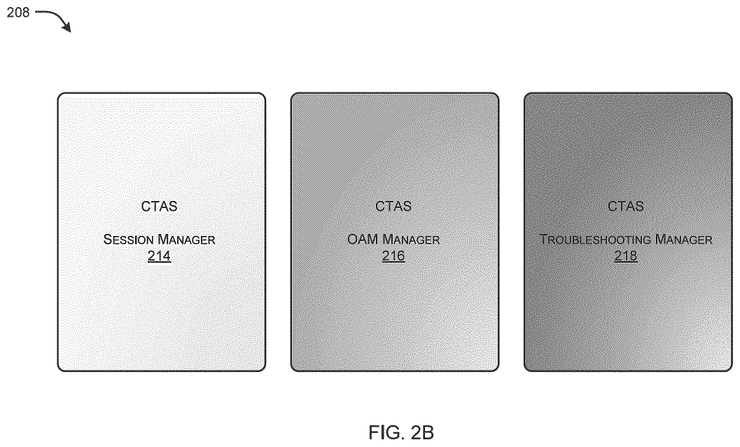

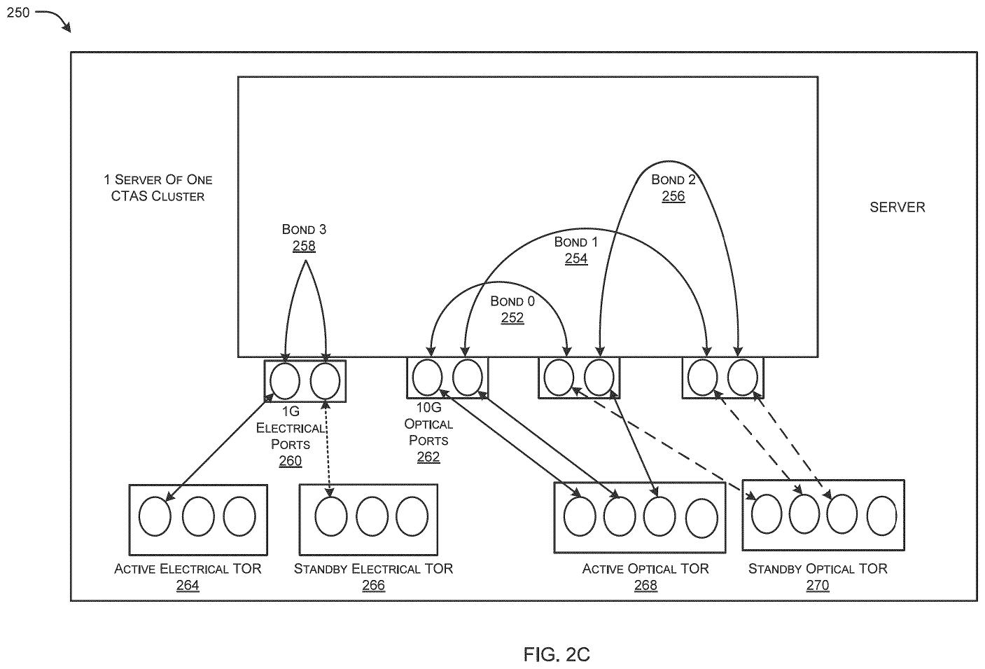

The system may facilitate the simultaneous communication by a combination of hardware and software implementation. FIG. 2A with reference to FIG. 1A, illustrates an exemplary representation of a network device, in accordance with an embodiment of the present disclosure. The system includes the network device or CTAS 102 that may include one or more processors. The network device or CTAS 102 may be integrated with IMS server 106 to provides a network service to a user device 110 (as shown in FIG. 1A). In an aspect, the network device 102 may include one or more processor(s) 202 coupled with a memory 204. The memory 204 may store instructions which when executed by the one or more processors may cause the system to perform the steps as described herein. The network device or CTAS 102 may cause the system to receive, through the IMS (106 of FIG. 1A), receive one or more predefined request signals from the UEs such as but not limited to INVITE. The CTAS 102 may cause the system to extract a set of attributes from the one or more predefined request signals, the set of attributes pertaining to a set of modes pertaining to a standardized bit rate such as AMR-BW at which speech modulation takes place. The CTAS 102 may determine, from the set of attributes extracted if the set of modes are specified. If the set of modes are not specified, the CTAS 102 may add, a predefined number of modes to the one or more predefined request signals. The CTAS 102 may further restrict, the set of modes to the predefined number of modes, if the set of modes exceed the predefined number of modes. The predefined number of modes may specify a range of modes from a minimum to an optimum value. For example, the predefined number may be 0, 1, 2 or 3.

So, for example, if an INVITE request has a set of modes more than 3, such as 5, the CTAS 102 may restrict the mode set to 3. If no set of modes is specified in the INVITE request, the CTAS 102 will provide the number 3 to the INVITE request as the mode set number.

In an example, the CTAS 102 is forcing the user to negotiate the set of modes not to exceed a predefined number. Alternatively, the UE can communicate only up to 14.25 kbits/sec. The system may then transmit the one or more predefined request signals with the added predefined number of modes to the UE 110.

In an embodiment, the user may select the predefined number of mode-sets while sending a session description protocol (SDP) answer for the incoming one or more predefined request signals as mandated by a set of predefined instruction protocol such as AMR-WB guidelines.

In an embodiment, if the set of modes are specified in the SDP, and if the set of modes exceed or fall short of the predefined number of numbers, the CTAS can modify the set of modes to the predefined number of modes.

In an example, the one or more processor(s) 202 may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 102. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as RAM, or non-volatile memory such as EPROM, flash memory, and the like.

In an embodiment, the CTAS 102 may include an interface(s) 206. The interface(s) 206 may comprise a variety of interfaces, for example, interfaces for data input and output devices, referred to as I/O devices, storage devices, and the like. The interface(s) 206 may facilitate communication of the CTAS 102. The interface(s) 206 may also provide a communication pathway for one or more components of the system 110. Examples of such components include, but are not limited to, processing engine(s) or a CTAS application (208), a CDL agent (210) associated with a CDL server (104) though a CDL layer (212).

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 110 may comprise the machine-readable storage medium storing the instructions and the processing resource to execute the instructions, or the machine-readable storage medium may be separate but accessible to the system 110 and the processing resource. In other examples, the processing engine(s) 208 may be implemented by electronic circuitry.

The processing engine 208 may include one or more components (as shown in FIG. 2B) including session manager (SM) 214, operations and maintenance (OAM) manager 216, and a troubleshooting manager (TM) 218. The SM 214 may act as core functional delivery module which may be responsible for call processing and service chaining logic execution in case of CTAS. The tasks of handling SIP, HTTP and Diameter messages are of the SM 214. In case of the CDL 104, the session manager job can interact with a database and to provide necessary information sought by the CDL agent 210. The OAM manager 216 may be responsible for managing fault, configuration and performance aspects of the CTAS/network device. The OAM manager 216 may provide operations and maintenance touch point to the system or the CTAS 102. The OAM 216 may be integrated with EMS/OSS on a RESTful Interface. The TM 218 may aggregate logs and may debug information from all the functional managers for trouble shooting. The TM 218 may also provide flexibility to generate debug information, for example, in a Module wise, process wise, system wise manner. Various other functions of the components may be possible. In an embodiment, the database (not shown in FIG. 2B) may comprise data that may be either stored or generated as a result of functionalities implemented by any of the components of the processing engine(s) 208 of the system 110.

FIG. 2C illustrates exemplary representation of a CTAS server, in accordance with embodiments of the present disclosure. As shown in FIG. 2C, the CTAS server is a cluster-based solution, and can be hosted on but not limited to COLT servers. Each server has at least four logical interfaces such as Bond0 252, Bond1 254, Bond2 256 and Bond3 258, where each Bond is a logically paired two ethernet ports to achieve link level redundancy. In an example, the Bond0 252 interface may be used by at least eight blades for internal and database communication. The Bond1 254 Interface can be used by SIP applications present in the at least eight servers for SIP signalling. The Bond2 256 interface may be used for diameter communication by applications present in Blade3 onwards for example, from Blade3 to Blade8, whereas the Bond3 interface can be used communication with the Element Management System (EMS). In another example, for Bond0 252, Bond1 254 and Bond2 256, 10G optical NIC cards 262 will be used, whereas for Bond3 258, 1G electrical NIC cards 260 will be used.

The CTAS can support both IPv4 and IPv6 protocols, where the Bond2 256 and the Bond3 258 interfaces listen on either IPv6 or IPv4 at a given point of time and Bond1 254 interface listens on IPv4 and IPv6 at the same time. The Bond0 252 interface, which is not used for any external communication supports only IPv4.

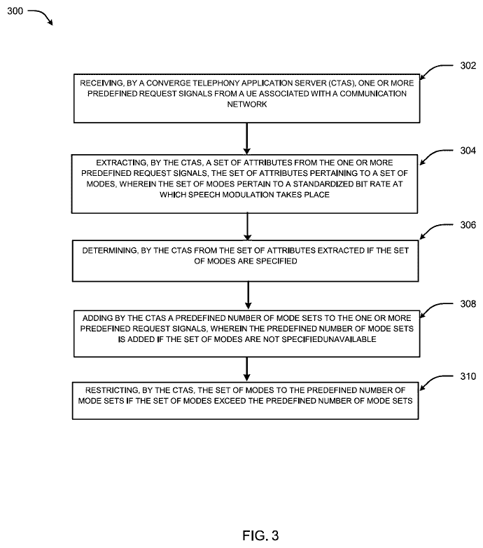

FIG. 3 illustrates an exemplary representation of a method flow diagram 300, in accordance with embodiments of the present disclosure. In an aspect, the method for mode set restriction during speech modulation in a communication network may include at 302, the step of receiving, by a converge telephony application server (CTAS), one or more predefined request signals from a UE associated with a communication network. The CTAS may be operatively coupled to the communication network and a centralized database.

The method 300 may also include at 304, the step of extracting, by the CTAS, a set of attributes from the one or more predefined request signals, the set of attributes pertaining to a set of modes pertaining to a standardized bit rate for speech modulation and at 306, the step of determining, by the CTAS from the set of attributes extracted if the set of modes are specified.

Further, the method 300 may include at 308, the step of adding by the CTAS a predefined number of mode sets to the one or more predefined request signals, where the predefined number of mode sets may be added if the set of modes are not specified.

Furthermore, at 310, the step of restricting, by the CTAS, the set of modes to the predefined number of mode sets if the set of modes exceed the predefined number of mode sets.

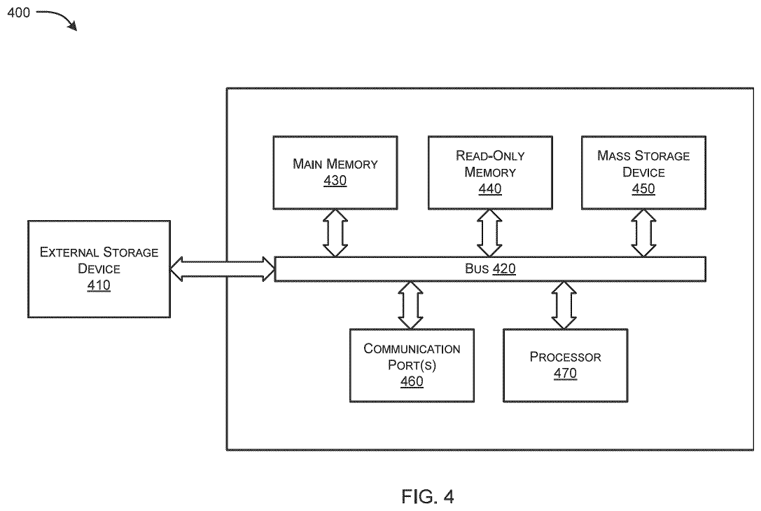

FIG. 4 illustrates an exemplary computer system in which or with which embodiments of the present invention can be utilized in accordance with embodiments of the present disclosure. As shown in FIG. 4, computer system 400 can include an external storage device 410, a bus 420, a main memory 430, a read only memory 440, a mass storage device 450, communication port 460, and a processor 470. A person skilled in the art will appreciate that the computer system may include more than one processor and communication ports. 4Processor 470 may include various modules associated with embodiments of the present invention. Communication port 460 can be any of an RS-232 port for use with a modem based dialup connection, a 10/100 Ethernet port, a Gigabit or 10 Gigabit port using copper or fibre, a serial port, a parallel port, or other existing or future ports. Communication port 460 may be chosen depending on a network, such a Local Area Network (LAN), Wide Area Network (WAN), or any network to which computer system connects. Memory 430 can be Random Access Memory (RAM), or any other dynamic storage device commonly known in the art. Read-only memory 440 can be any static storage device(s) e.g., but not limited to, a Programmable Read Only Memory (PROM) chips for storing static information e.g., start-up or BIOS instructions for processor 470. Mass storage 450 may be any current or future mass storage solution, which can be used to store information and/or instructions.

Bus 420 communicatively couples processor(s) 470 with the other memory, storage and communication blocks. Bus 420 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g. a display, keyboard, and a cursor control device, may also be coupled to bus 420 to support direct operator interaction with a computer system. Other operator and administrative interfaces can be provided through network connections connected through communication port 460. 4Components described above are meant only to exemplify various possibilities. In no way should the aforementioned exemplary computer system limit the scope of the present disclosure.

Thus, the present disclosure provides a technical solution for facilitating an effective and concurrent reduction in bandwidth by restricting a set of modes to a predefined number of modes without any loss in signal strength.

It would be appreciated that the embodiments herein are explained with respect to network device or CTAS, however, the proposed system and method can be implemented in any computing device or external devices without departing from the scope of the invention.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. The patent document includes systems and methods as defined in 3GPP Technical Specification (TS) 3GPP TS 26.114, 3GPP TS 26.441 and the like.

### ADVANTAGES OF THE PRESENT DISCLOSURE

The present disclosure facilitates an effective, concurrent and improved signal quality with a restricted mode set value.

The present disclosure provides for a system that maintains an optimal bandwidth.

The present disclosure facilitates careful and efficient use of resources in the network.

We claim:

1. A system for mode set restriction during speech modulation in a communication network, the system comprising:
at least one converge telephony application server (CTAS) in communication with a user equipment (UE) associated with a predefined circle in the communication network and a centralized database,
wherein the at least one CTAS is operatively coupled to a processor, the processor being coupled to a memory, the memory storing instructions on execution of which, the processor causes the at least one CTAS to:
receive one or more predefined request signals from the UE;
extract, a set of attributes from the one or more predefined request signals, the set of attributes pertaining to a set of modes, wherein the set of modes pertain to a standardized bit rate for speech modulation;
determine, from the extracted set of attributes, if the set of modes are specified;
add a predefined number of mode-sets to the one or more predefined request signals if the set of modes are unavailable; and
restrict the set of modes to the predefined number of mode-sets, if the set of modes exceed the predefined number of mode-sets.

2. The system as claimed in claim 1, wherein the one or more predefined request signals with the added predefined number of mode sets are transmitted to the UE.

3. The system as claimed in claim 1, wherein the predefined number of mode-sets is within a predefined frequency range.

4. The system as claimed in claim 1, wherein the at least one CTAS is operatively coupled to one or more communication interfaces for communicating with the UE via one or more channels selected from a group consisting of: telephonic calls, web-based voice communications, voice-over-IP communications, and wherein the one or more communication interfaces are associated with a session description protocol (SDP), the SDP comprising one or more control signals for a plurality of service sessions and protocols for service use by the UE.

5. The system as claimed in claim 4, wherein the one or more predefined request signals comprises a field for the SDP, said field being configured for setting the predefined number of mode-sets by a user associated with the UE as mandated by a set of predefined instruction protocol.

6. The system as claimed in claim 5, wherein if the set of modes is specified in the SDP and wherein the set of modes is not within a predefined frequency range, the at least one CTAS is configured to modify the set of modes to the predefined number of mode-sets.

7. The system as claimed in claim 1, wherein the system is configured to exceed the predefined number of mode-sets based on underlying network condition.

8. A method for mode set restriction during speech modulation in a communication network, the method comprising:
receiving, by a converge telephony application server (CTAS), one or more predefined request signals from a UE associated with a communication network, wherein the CTAS is operatively coupled to the communication network and a centralized database;
extracting, by the CTAS, a set of attributes from the one or more predefined request signals, the set of attributes pertaining to a set of modes, wherein the set of modes pertain to a standardized bit rate at which speech modulation takes place;
determining, by the CTAS from the extracted set of attributes, if the set of modes are specified;
adding by the CTAS a predefined number of mode sets to the one or more predefined request signals, wherein the predefined number of mode sets is added if the set of modes are unavailable; and,
restricting, by the CTAS, the set of modes to the predefined number of mode sets if the set of modes exceed the predefined number of mode sets.

9. The method as claimed in claim 7, wherein the method further comprises:
transmitting, by the at least one CTAS, the one or more predefined request signals with the added predefined number of mode sets to the UE.

10. The method as claimed in claim 8, wherein the predefined number of mode sets lie in a predefined frequency range.

11. A user equipment (UE) for mode set restriction during speech modulation in a communication network, the UE comprising:
at least one converge telephony application server (CTAS) in communication, wherein the at least one CTAS is operatively coupled to a processor, wherein the processor is further coupled to a memory, the memory storing instructions on execution of which, the processor causes the at least one CTAS to:
receive one or more predefined request signals from the UE;
extract a set of attributes from the one or more predefined request signals, the set of attributes pertaining to a set of modes, wherein the set of modes pertain to a standardized bit rate for speech modulation;
determine, from the extracted set of attributes, if the set of modes are specified;
add a predefined number of mode-sets to the one or more predefined request signals if the set of modes are unavailable; and
restrict the set of modes to the predefined number of mode sets, if the set of modes exceed the predefined number of mode-sets.

12. The UE as claimed in claim 11, wherein the predefined number of mode-sets is within a predefined frequency range.

13. The UE as claimed in claim 11, wherein the at least one CTAS is operatively coupled to one or more communication interfaces for communicating with the UE via one or more channels selected from a group consisting of: telephonic calls, web-based voice communications, voice-over-IP communications, and wherein the one or more communication interfaces are associated with a session description protocol (SDP), the SDP comprising one or more control signals for a plurality of service sessions and protocols for service use by the UE.

14. The UE as claimed in claim 13, wherein the one or more predefined request signals comprises a field for the SDP, said field is configured for setting the predefined number of mode-sets by a user associated with the UE as mandated by a set of predefined instruction protocol.

15. The UE as claimed in claim 14, wherein if the set of modes is specified in the SDP and wherein the set of modes is not within a predefined frequency range, the at least one CTAS is configured to modify the set of modes to the predefined number of mode-sets.

16. The UE as claimed in claim 11, wherein the at least one CTAS is configured to exceed the predefined number of mode-sets based on underlying network condition.

17. The UE as claimed in claim 11, wherein the at least one CTAS is configured to calculate a mean opinion score (MOS) with respect to the predefined number of mode-sets.

18. A non-transitory computer readable medium comprising machine-executable instructions that are executable by a processor to:
receive one or more predefined request signals from a user equipment (UE);
extract a set of attributes from the one or more predefined request signals, the set of attributes pertaining to a set of modes, wherein the set of modes pertain to a standardized bit rate for speech modulation;
determine, from the extracted set of attributes, if the set of modes are specified;
add a predefined number of mode-sets to the one or more predefined request signals if the set of modes are unavailable; and
restrict the set of modes to the predefined number of mode-sets, if the set of modes exceed the predefined number of mode-sets.
